(19) United States
(12) Patent Application Publication
(10) Pub. No.: US 2011/0131202 A1
(43) Pub. Date: Jun. 2, 2011

(54) EXPLORATION OF ITEM CONSUMPTION BY CUSTOMERS

(75) Inventors: Doron Cohen, Mitzpe Gilon (IL); Iris Eiron, Ein Ayyala (IL); David Konopnicki, Haifa (IL); Naama Kraus, Haifa (IL)

(73) Assignee: International Business Machines Corporation, Armonk, NY (US)

(21) Appl. No.: 12/629,057

(22) Filed: Dec. 2, 2009

(51) Int. Cl. G06F 17/30; G06F 3/048

(52) U.S. Cl. 707/723; 707/741; 715/810; 707/E17.002; 707/769; 707/E17.108

(57) ABSTRACT

A method, system and computer program product for exploration of item consumption by customers are provided. The method includes profiling each customer with self attributes and related attributes in the form of consumed items; profiling each item with self attributes, first order related attributes in the form of customers of the profiled item, and second order related attributes in the form of items consumed by the customers of the profiled item; and indexing the customer profiles and item profiles in a faceted search engine for exploration by a user. Searching the customer profiles and item profiles is carried out by user selection of one or more attributes of the customers and/or items. The method includes refining the indexed profiles to a segment of the data in the form of a compound logic condition of the attributes of the customer and/or items.

### FIELD OF THE INVENTION

This invention relates to the field of data analysis. In particular, the invention relates to exploration of item consumption by customers.

### BACKGROUND OF THE INVENTION

Companies today are aggregating huge amounts of data about their customers but are not always able to fully take advantage of this data for commercial purposes. This problem usually articulates into two challenges. First, customer data is dispersed in various systems, using different data formats, coding schemes, and so forth, thereby requiring integration. Second, tools are needed to explore and analyze this data, making sense of it in order to give it value and enable its use.

A flexible system is required to make aggregated customer data accessible directly to marketers and customer relationship management (CRM) analysts in an interactive way.

### SUMMARY OF THE INVENTION

According to a first aspect of the present invention there is provided a method for exploration of item consumption by customers, comprising: profiling each customer with self attributes and related attributes in the form of consumed items; profiling each item with self attributes, first order related attributes in the form of customers of the profiled item, and second order related attributes in the form of items consumed by the customers of the profiled item; indexing the customer profiles and item profiles in a faceted search engine for exploration by a user; wherein said profiling and indexing steps are implemented in either: a) computer hardware configured to perform said profiling and indexing steps; or b) computer software embodied in a non-transitory, tangible, computer-readable storage medium.

According to a second aspect of the present invention there is provided a computer program product for exploration of item consumption by customers, the computer program product comprising: a computer readable medium; computer program instructions operative to: profile each customer with self attributes and related attributes in the form of consumed items; profile each item with self attributes, first order related attributes in the form of customers of the profiled item, and second order related attributes in the form of items consumed by the customers of the profiled item; index the customer profiles and item profiles in a faceted search engine for exploration by a user; wherein said program instructions are stored on said computer readable medium.

According to a third aspect of the present invention there is provided a system for exploration of item consumption by customers, comprising: a processor; a profiling component for: profiling each customer with self attributes and related attributes in the form of consumed items; profiling each item with self attributes, first order related attributes in the form of customers of the profiled item, and second order related attributes in the form of items consumed by the customers of the profiled item; a faceted search engine including an indexing component for indexing the customer profiles and item profiles in a faceted search engine for exploration by a user; wherein any of said profiling component, faceted search engine and indexing component are implemented in either of computer hardware or computer software and embodied in a non-transitory, tangible, computer-readable storage medium.

According to a fourth aspect of the present invention there is provided a user interface for exploration of item consumption by customers, comprising: a display of aggregated customer profiles and item profiles, wherein a customer profile includes self attributes and related attributes in the form of consumed items, and an item profile includes self attributes, first order related attributes in the form of customers of the profiled item, and second order related attributes in the form of items consumed by the customers of the profiled item; a selection component for selecting one or more attributes of the customer and/or items displayed; a refining component for displaying a segment in the form of a compound logic condition of the attributes of the customer and/or items.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIGS. 3A and 3B are schematic diagrams of components in accordance with the present invention;

FIGS. 4A to 4D are representations of displays of a graphical user interface in accordance with the present invention; and

FIG. 5 is a flow diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are described for exploration of item consumption by customers in a marketing application based on a two-phase model.

In the first phase:
For each customer, a “customer profile” is summarized of the items of consumption of the customer. The customer profile contains attribute histograms that characterize the items consumption of this user. For example: 80% action movies and 70% jazz music.
For every item, an “item profile” is summarized of the attributes of the customers that have consumed this item. This profile contains for example: 70% Males, 40% Urban.
   In the second phase, the user profiles including customer and item profiles are loaded into a faceted search engine. The facets mechanism allows exploration of the various segments summing up the statistics.

An analysis framework is provided based on a historical transaction load. This framework allows companies to understand better their customers and products. This enables the companies, for example, to create optimized marketing or advertisement campaigns. This information is accessible through a marketing and targeting graphical user interface (GUI).

Using the framework, companies can better understand and target their customers, improving the up-sale and cross-sale of the company's line of products. The framework's flexibility enables it to model almost any kind of customers and products, services or content and the different types of relationships that can exists between them.

The framework processes three types of information:
Information about customers: for example, gender, age, and income.
Information about items made available to customers: for example, with regard to a downloadable song, the singer, author, and lyrics.
Customer behaviour with respect to item consumption, browsing, etc.: for example, which items a customer purchased, browsed, and tagged. Additional characteristics of the transaction may vary, such as timestamp, price, and format.

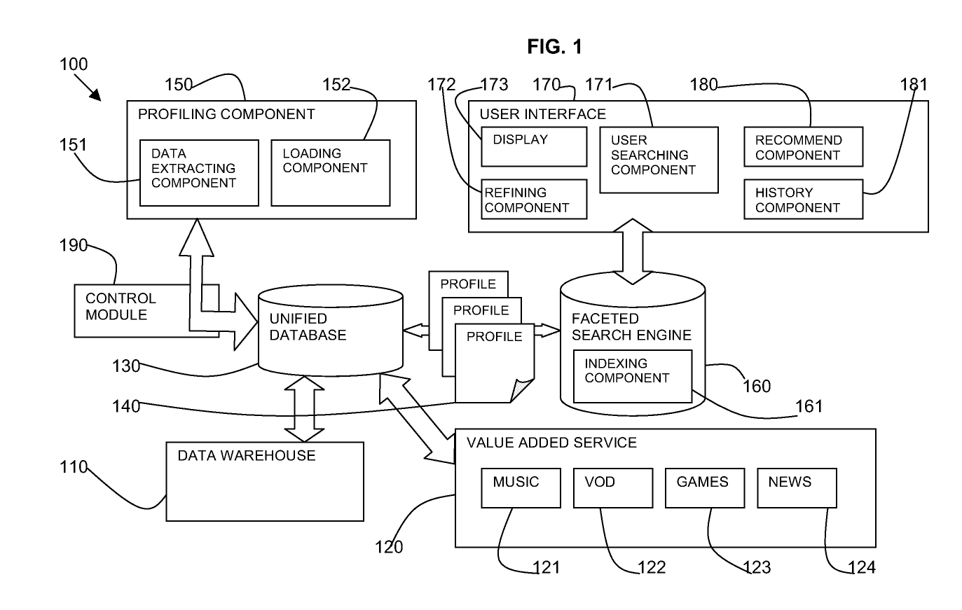

Referring to FIG. 1, an analysis framework 100 is shown. In a typical scenario, the framework 100 extracts and integrates data from a data warehouse 110 containing users' demographics and billing information, together with data pertaining to different telecommunication value-added services 120 (VAS: music download 121, video-on-demand 122, games 123, news 124, etc.). The framework 100 stores this information in a unified database 130 and computes profiles 140 using a profiling component 150 in the form of a profile computing platform using machine learning, statistics, text analysis, etc. The profiling component 150 includes a data extracting component 151 for extracting data for customer and item profiles 140 and a loading component 152 for loading the data into the unified database 130. A control module 190 is provided which orchestrates the workflow and refreshes data. The control module 190 loads data into the unified database 130, uses the profiling component 150 to compute customer and item profiles and loads the profiles to the faceted search engine 160 using the indexing component 161.

The framework 100 exports the profiles 140 to a faceted search engine 160 so the information can be explored. The faceted search engine 160 includes an indexing component 161.

A user interface 170 is provided in the form of a marketing and targeting tool. The user interface 170 includes a display 173 and a user searching component 171 for a user to select segments and a refining component 172 for displaying a selected segment with calculated derived attributes. The user interface 170 includes a recommendation component 180 and a history component 181 to provide online recommendation services with on-the-fly recommendation, popularity, and similarity services, and history of previous data.

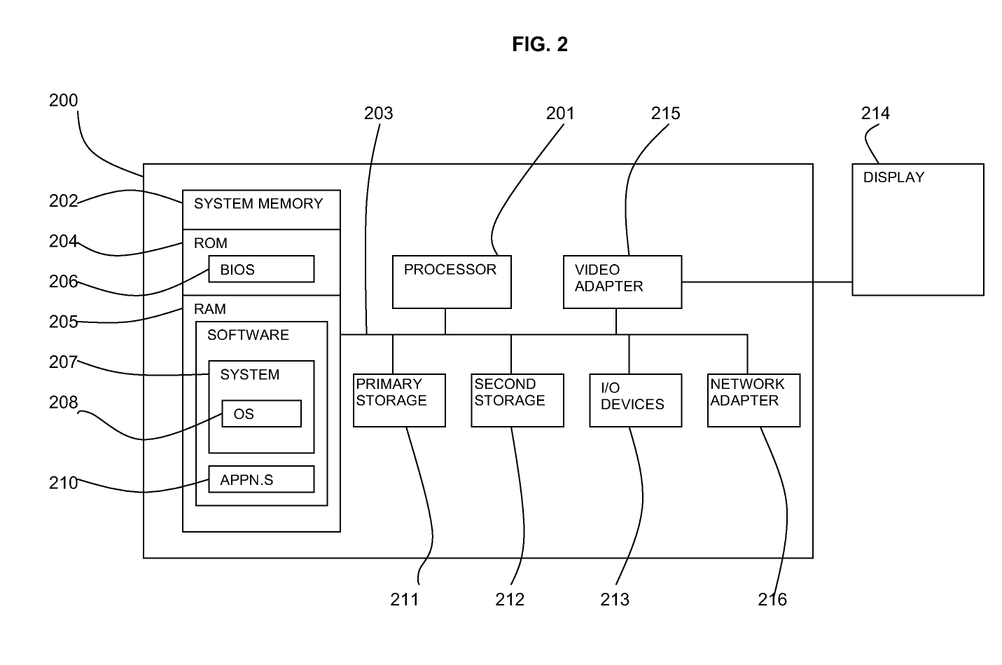

Referring to FIG. 2, an exemplary system for implementing aspects of the framework includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

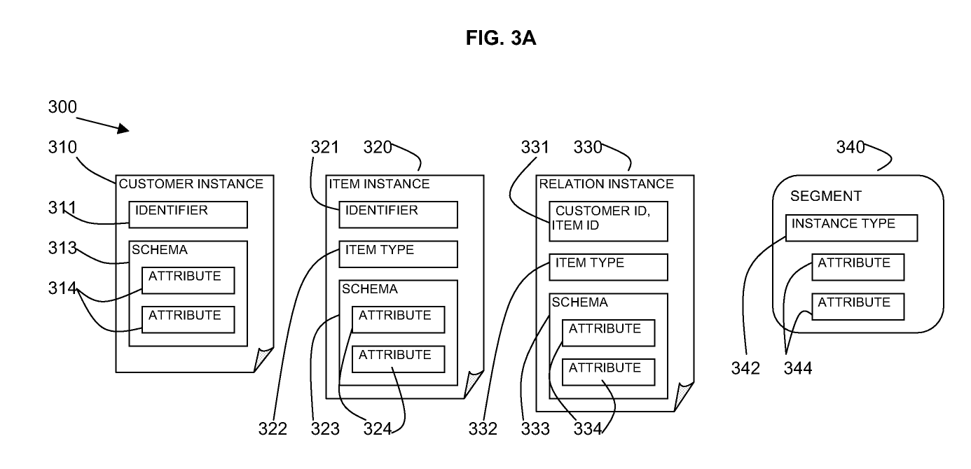

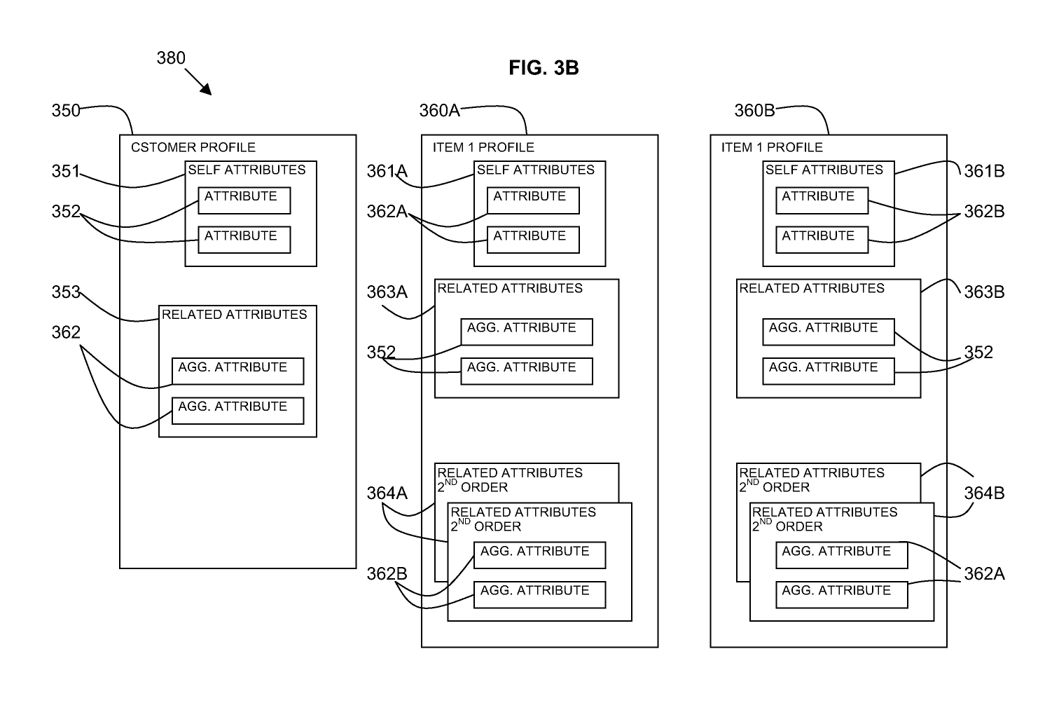

Referring to FIGS. 3A and 3B, schematic diagrams 300, 380 show the components of the data model used in the analysis framework.

### Instances

The data model of the framework uses the basic concepts of customers and items. A specific customer instance 310 has a unique identifier (ID) 311 that uniquely identifies this particular customer (i.e., social security number, driver license, or subscriber ID). Similarly, a specific item instance 320 has a unique ID 321 that uniquely identifies this particular item. A third concept, which is the relationship instance 330 between the two (i.e., a specific purchase association), has an ordered pair 331 of the customer instance ID and the item instance ID participating in the relation.

Customers correspond to the actual end-users, while items can be anything that needs to be tracked and analyzed through the framework, including products purchased, services or content accessed, or advertisements displayed.

There may be several different types of relationships between customers and items: for example, it is possible to differentiate between browsed data and downloaded data or between viewed advertisements and clicked advertisements. It is also possible to use relationships to represent a customer using or leaving a fidelity plan. Thus, a relationship instance specifies a link between a customer and an item; for example, this customer has accessed this item.

Each of these instance concepts 310, 320, 330 may have a variable number of attributes that are numeric, categorical, or free text. These attributes can be restricted to certain domains, such as a positive value for a certain numeric attribute. For example, a customer's attributes may contain a numeric age attribute and a Boolean gender attribute. A relationship's attributes corresponding to the download of a music file may contain a categorical attribute format and a numeric attribute release date.

All customer instances 310 share the same schema 313 in the sense that they all have the same set of attributes 314 along with the attribute type and constraints. An item instance 320 has a special field 322 indicating the type of the item (for example, music, game, or ring-back tone). Item instances 320 belonging to the same type share a single schema 323 of attributes 324. Similarly, relationship instances 330 associated with the same item type 332 share a single schema 333 of attributes 334.

### Segments

By definition, a segment 340 of customers or a segment of a certain item type (for example, a music segment or a movie segment) is a compound logical condition.

The segment 340 is a compound logical condition of customer or instance types 342 and attributes 343. AND, OR, NOT relationships between attributes can be used to compose any Boolean condition.

For example, the condition [Customer AND gender==‘M’ AND location==‘Taipei’] represents the segment of male customers living in Taipei. [Movie AND genre=‘Action’] represents the segment of action movies. [Music AND genre=‘Jazz’] represents the jazz music segment.

Given a segment 340, the framework is capable of identifying the particular instances 310, 320, 330 that belong to the segment 340 and computing their characteristics. For example, the framework can determine that [Customer AND gender==‘M’ AND location=‘Taipei’] consumes 60% house music and 40% pop. [Music AND genre=‘Jazz’] is consumed mostly by middle-aged men.

End-users do not need to interact with the system through the formal definition of segments 340. Instead, the framework's marketing and targeting tool allows them to explore dynamically the various segments represented graphically.

### Profiles

Given customers, items, and the relationships linking them, the framework computes profiles 350, 360A, 360B as shown in FIG. 3B.

The profile of a customer 350 is composed of two parts:
Self attributes 351: These are attributes 352 of the customer such as age and gender are usually extracted from a data warehouse or a CRM system.
Related attributes of the first order 353: These are the aggregated self attributes of the items 362 linked to the customer by a given relationship (for example, consumed by) such as movies genres, languages, songs, singers, and composers. These attributes are aggregated through the framework's profiling algorithms and characterize the item consumption of this particular customer. An aggregation function is used for example COUNT. For example, say a customer is related to 7 songs with attribute “genre=pop-music”, 2 songs with attribute “genre=jazz” and one song with attribute “genre=rock”, while the aggregation function is COUNT, that is counting the different values of each attribute, then the related attributes of a customer may characterize the music consumption of a particular user as 70% pop music, 20% jazz, and 10% rock. This means that the related attributes of this customer are defined to be “music.genre.pop-music=70%”, “music.genre,jazz=20%”, “music.genre.rock=10%”. Thus, the related attributes do not contain the details of each item related to the customer at hand. Instead, the aggregation function is used to store statistics about the item consumption into the user profile. In the same way, the related attributes of a customer may characterize the advertisements this customer has clicked in the past as 30% sports items and 70% technology items. Different aggregation functions like AVG, SUM etc. can be used when defining the related attributes 353.

The profile of an item 360A, 360B is composed of three parts:
Self attributes 361A, 361B: These are attributes of the item 362A, 362B, such as genre and language (for a movie), usually obtained from an item catalogue. Another possibility is that the attributes of an item are computed based on the analysis of the item's content. For example, for an item that represents a news article, it is possible to analyze the text of the article and associate the item with the subject ‘sports’.
Related attributes of the first order 363A, 363B: These are the aggregated self attributes 352 of the customers that are linked with this item (for example, purchased it), such as age and gender, characterize the customers that have been consuming this product. For example, the attributes of an item may characterize it as consumed by 70% children and 30% teenagers. The aggregated attributes are computed in the same way as the related attributes of the customers.
Related attributes of the second order 364A, 364B: These are the aggregated self attributes of items 362B, 362A purchased by the customers that purchased this item. Those attributes characterize the other products that have been consumed together with this particular product. For example, the related attributes may specify that a particular song is consumed by customers whose movie consumption is characterized by 70% action movies and 30% romantic comedies.

The profile of a set of particular customers or items is the aggregation of the profiles 350, 360A, 360B of the individual members of the set. The profile of a set of customers characterizes the item consumption of the users that belong to the set. Identically, the profile of a set of items characterizes the users that consume those items.

The profile of a segment is the profile of the particular instances that belong to the segment.

### Profiling

The framework has the ability to collect information about customers, items, and the relationships between them, analyze the data, and distil it into profiles of customers and items.

The framework supports three types of profiles: profiles of individual instances (customers and items), profiles of sets of individual instances, and profiles of segments. For example, the profile of customer ‘John Doe’ contains both demographic attributes (self attributes) such as age and gender, as well as Doe's preferences such as ‘likes jazz music’ (expressed in fact as, Doe consumes 80% Jazz music).

The profile of the segment ‘male customers who lives in Taipei’ contains histograms with the ages of these customers and other self attributes and preferences computed by analyzing the products that have been consumed by customers belonging to this segment. So for example, the profile of the segment may indicate that ‘male customers who lives in Taipei’ prefer Sports News since 90% of the News they access belongs to this category.

Profiles of particular customers are computed by summarizing the information about the items that are linked to the user, that is computing the related attributes of the customer. Profiles of particular items are computed by summarizing the information about the customers that are linked to this item that is computing the related attributes of this item.

Profiles of segments are computed dynamically when a segment is explored by summing up the characteristics of the instances that belong to this segment. This is achieved by indexing into a faceted search engines that profiles of customers and segments together with their related attributes expressed as facets. A segment is expressed as a Boolean condition and submitted to the index as a query. The profiles that satisfy the query and thus belong to the segment are retrieved by the search engine and the facets of the profiles are computed thus providing the consumption information.

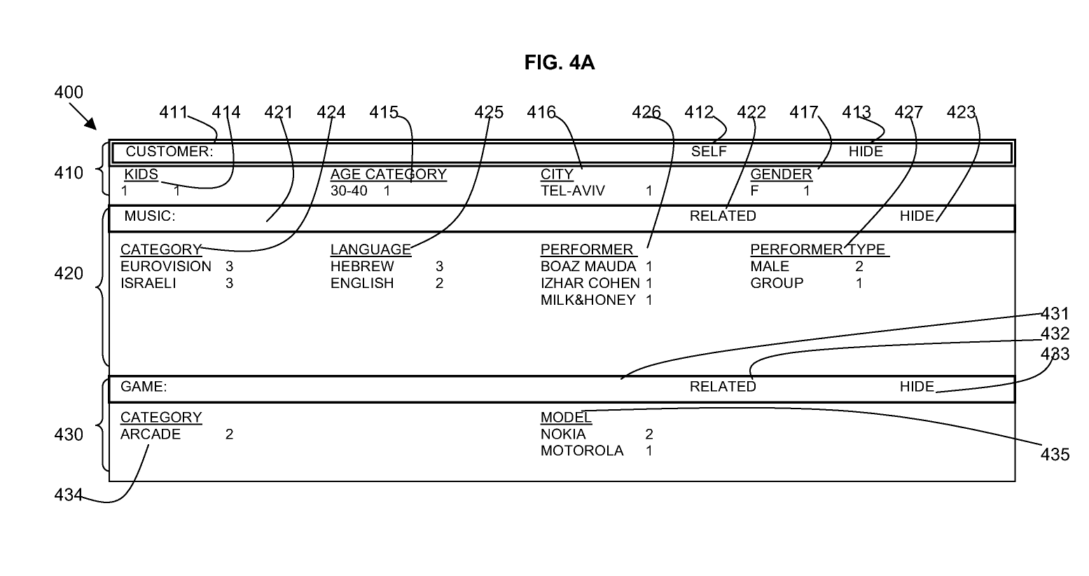

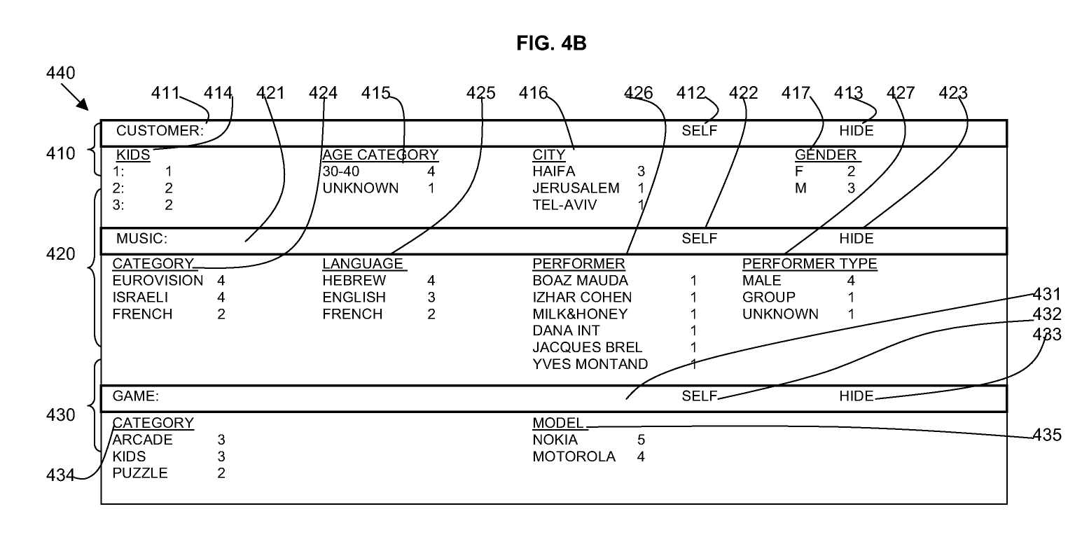

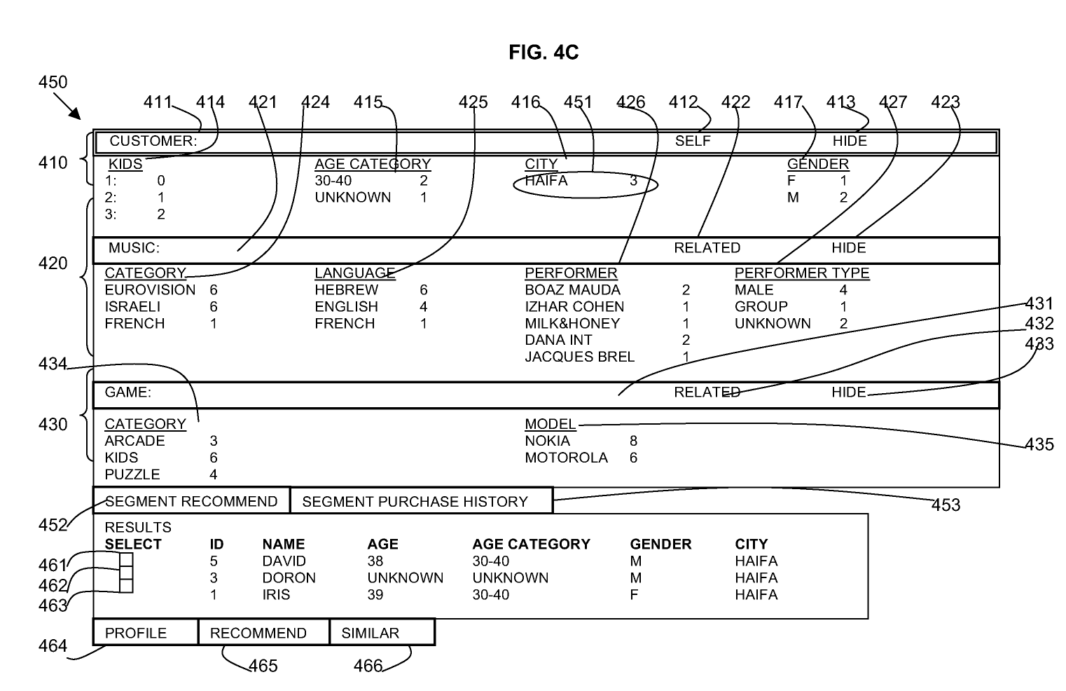

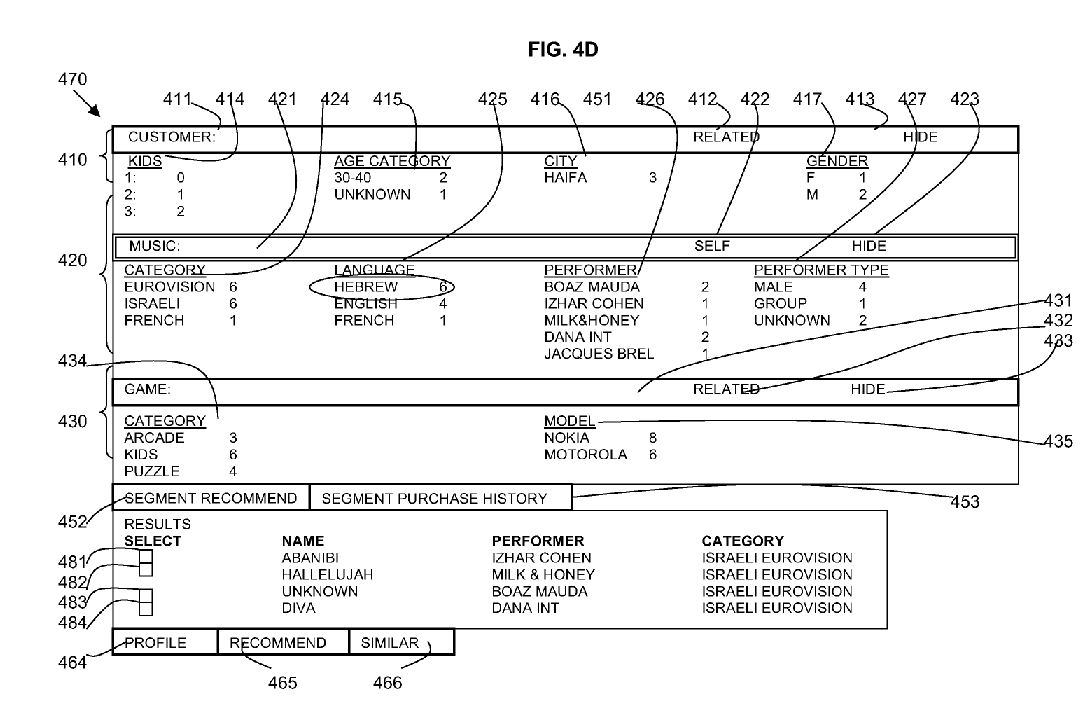

Referring to FIGS. 4A to 4D, graphical user interface (GUI) displays are shown. FIG. 4A shows a user profile of a customer 400.

The user profile 400 includes a panel 410 of a header 411 and self attributes 414-417. The panel 410 has a header 411 of “Customer” 411 which is highlighted as the user profile 400 is displayed for this customer. The panel header 411 includes the indications of “Self” 412 and “Hide” 413. “Self” 412 indicates that self attributes 414-417 are displayed. “Hide” 413 can be selected to hide the panel 410.

The self attributes 414-417 illustrated in this example are number of children 414, age category 415, city of residence 416, and gender 417. As this is a particular customer's profile, there is one value in each self attribute 414-417.

The user profile 400 also includes panels 420, 430 for item types. The panels 420, 430 each have panel headers 421, 431 and attributes 424-427, 434-435.

The panel header 421 of the panel 420 has an item type of “Music” and an indication of “Related” 422 to indicate the attributes 424-427 values displayed are aggregated related attribute values. An option of “Hide” 423 is provided which can be selected to hide the panel 420.

The attributes 424-427 display statistics for the items of type music which have a given relationship to the user whose user profile 400 is displayed. For example, in this illustrated embodiment the relationship is items consumed by the user.

The attributes 424-427 of this example are: category 424 including Eurovision, Israeli; language 425 including Hebrew, English; performer 426 including Boaz Mauda, Izhar Cohen, Milk & Honey; and performer type 427 including male, group.

Similarly, the panel header 431 of the panel 430 has an item type of “Games” and an indication of “Related” 432 to indicate that displayed attributes 434-435 are aggregated related attribute values. An option of “Hide” 433 is provided which can be selected to hide the panel 430.

The attributes 434-435 display statistics for the items of type games which have a given relationship to the user whose user profile 400 is displayed. The attributes 434-435 of this example are: category 434 including arcade; and model 435 including Nokia, Motorola (Nokia and Motorola are trade marks of Nokia Corporation and Motorola, Inc. respectively).

The derived aggregated related attributes 424-427 for music show that in this example 3 songs with language Hebrew and 2 songs with Language English have been consumed. The attributes 414-417, 424-427, 434-435 are represented as navigational facets in a faceted search engine.

FIG. 4B shows a display 440 of a total population in which the attributes of customers, music, and games are displayed in the form of self attributes. The panel headers 411, 421, 431 all indicated that the panels 410, 420, 430 related to “Self” 412, 422, 432.

This display 440 shows the facets' values for the whole population for the customers and the items. For example, for the customers, it can be seen that 3 customers leave in Haifa, 1 in Jerusalem and 1 in Tel-Aviv. For the games, there are 3 arcade games, 2 puzzles and 3 kids' games.

User selection of a facet (for example, by clicking on it with a user input device) in the form of one of the categories of attribute 414-417, 424-427, 434-435 will sum up the derived aggregated attributes of the customer or item profiles.

Referring to FIG. 4C, a segment is displayed 450 for customers with a place of residence of Haifa. A user has selected 451 the attribute 416 of city in the customer panel 410. Selecting the attribute category of Haifa displays the statistics about the music and game consumption of the customers living in Haifa:

It can be seen that the panels 420, 430 for music and games are now “Related” 422, 432. Customers living in Haifa have consumed 6 songs with language Hebrew and 6 games with category Kids.

The attribute values shown in this example, are consumption values of the item. Therefore, 6 Hebrew songs have been consumed even through the total population display 440 showed that there were only 4 Hebrew songs. One song can be consumed more than once.

At any point, a user can select another attribute (for example, by clicking on it) in order to update the definition of the segment currently being analyzed.

The display 450 includes options of “Segment Recommend” 452, and “Segment Purchase History” 453. For a displayed segment, a further display of recommendations or history may be shown.

The display 450 also shows the actual users 461-463 that belong to this segment (City=Haifa). Further options for each of the users 461-463 can be selected such as the “Profile” 464, “Recommend” 465, and “Similar” 466.

Referring to FIG. 4D, a segment is displayed 470 for an item facet, in this example, language of music is selected as Hebrew. A user has selected 471 the attribute 425 of Hebrew language of music in the music panel 420.

It can be seen that the music panel 420 is now indicated as “Self” 422 and the customer panel 410 and games panel 430 are indicated as “Related” 412, 432. Hebrew songs have been consumed 6 times by customers living in Haifa and 3 times by customers of Arcade games.

As in FIG. 4C, the display 470 also shows the actual songs 481-484 that belong to the segment (Music Language=Hebrew).

### Search and Similarity Calculations

The complexity of a segment's definition may vary. It can be very simple, such as [Customer AND gender==‘M’], or it can be more complex, imposing constraints on the self and related attributes of the schema; for example, male teenagers whose music consumption is more than 70% rock music.

Similarly, an item segment may define songs that are consumed by teenagers living in a particular region.

Given a segment definition, the framework system identifies the particular instances that belong to the segment. The instances are ranked according to their similarity to the given condition. For example, given the expression [Customer AND gender==‘M’ AND location==‘Taipei’], it is expected that male customer ‘John Doe’ living in Taipei is ranked higher than customer ‘John Smith,’ who lives in Keelung. The retrieved instances are shown in FIG. 4C in the form of displayed users 461-463 and in FIG. 4D in the form of displayed songs 481-484.

With this functionality, a particular user or a particular item can be used as an example to retrieve the most similar users and items. This capability of finding similar customers and items can be accessed directly by users of the framework through the marketing and targeting tool. It can also be embedded into an existing application through the framework's API, thereby providing functionalities such as “People that have the same taste as you” and “Similar products”. In the user interface, it is executed by selecting a customer or an item and selecting the “Similar” button 466 shown in FIGS. 4C and 4D.

### Attributes Aggregation

Retrieving the instances that belong to a particular segment entails the aggregation of the attributes of those instances. Thus, when searching for a segment, the user of the framework is not only presented with the particular instances that belong to this segment but also with the statistics characterizing those instances.

For example, when examining a segment of male teenagers, the aggregated attributes of the instances may teach us the distribution of the music genre consumed by those customers or the type of advertisements they click.

### The Marketing and Targeting Tool

The marketing and targeting tool, an example embodiment of which is illustrated in FIGS. 4A to 4D, enables CRM analysts, marketers, product managers, and campaign managers to explore the profile information and use it to better target their campaigns. The framework provides a flexible and powerful search engine to explore this information.

### Multifaceted Search

In the provided user interface, the framework enables guided navigation or multifaceted search of customers and items. Users can choose and filter according to the attributes most important to them when dynamically defining and exploring segments. The resulting list of customers or items matching their criterion remains in the search results and the facets are updated to show only valid choices of what is left. At each step, the statistics that characterize those segments are updated.

Using this multifaceted search, CRM analysts, product managers, marketers, or campaign managers can easily navigate the information gathered by the framework to identify interesting segments, understand what characterizes them, and use those segments for marketing or advertisement campaigns.

### History Navigation

The framework enables navigation through the historical transaction logs of an individual, a set of individuals, or a segment. Given a particular customer, the system retrieves the items linked to this customer over a certain time period. In a similar way, given a certain item, for example, a service, the system pulls out the list of customers who are linked this item over a certain period of time. This capability may be applied to an individual instance, a set of instances, or a segment. The ranking of the individual items/customers may take into account the popularity of the items/activity level or the customers.

The goal of the described method and system is to allow dynamic exploration of cross-domain item consumption in a marketing application: that is to allow end-users to ask queries on the relationships between particular user segments and items consumed by those segments.

By ‘dynamic’ exploration, it is meant that the queries are not known upfront but are processed as they are formulated by the end-user. By ‘cross-domain’, it is meant that the queries can relate on two different types of items (for example, “What type of movies are consumed by consumers of Jazz music?”).

Example of possible queries are as follows:
What characterize the items consumed by males between 20 and 30 years old that live in Tel-Aviv?
What characterize the consumers of Jazz music?
What type of movies are consumed by consumers of Jazz music? etc.
   This type of business intelligence system is usually implemented using online analytical processing (OLAP) technology: the transactions are saved in a relational database, various levels of summaries are pre-computed in order to allow the manipulation of data cubes by end-users to answer queries.

A system for exploration of item consumption by customers may be provided as a service over a network.

### Recommendation

Similarity of users or items profiles can be computed by submitting a profile as a query to the search index in which the profiles has been indexed. As a result, “similar” profiles are returned by the search engine. This mechanism is used in order to provide recommendations:
Given a particular user, it is possible to submit her profile as a query, finding “similar” users. By examining the purchase history of those users, it is possible to recommend popular items from this set of users.
Given a particular item, it is possible to find similar items in the same way and recommend the set of users candidate for purchasing this particular item.

### System Workflow

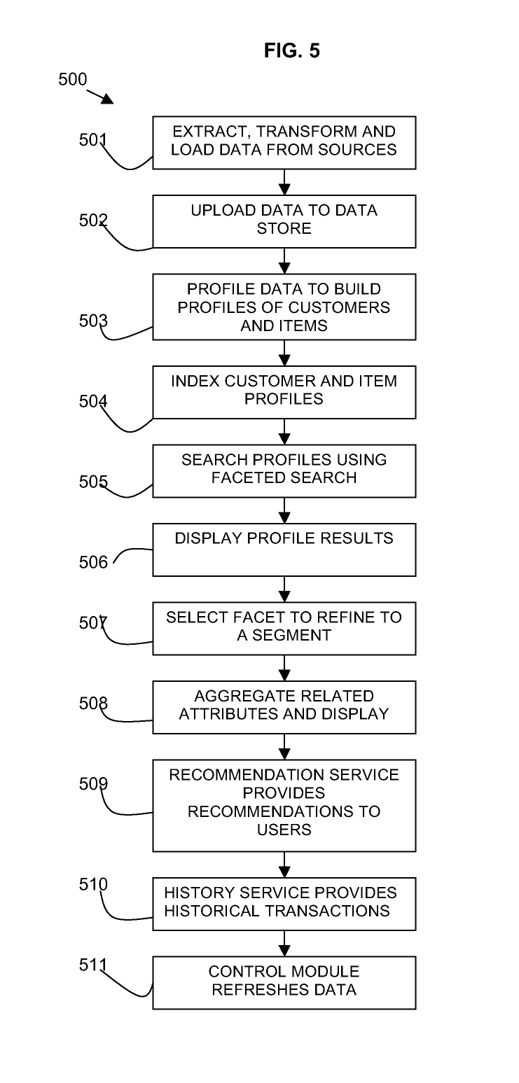

Referring to FIG. 5, a system workflow is shown as a flow diagram. The system workflow includes a first step of extracting, transforming, and loading 501 data from various sources into the framework. The data is uploaded 502. Profiling 503 is carried out by analyzing the datastore and building profiles of customers and items that is computing the related attributes. The customer and item profiles are indexed 504.

Customer and item profiles are searched 505 using faceted search and a displayed 506. A facet is selected 507 to refine to a segment. Related attributes are aggregated 508 and displayed.

A recommendation service provides 509 a service that obtains recommendations for users. A history service provides 510 details of historical transactions. A control module refreshes 511 data in the system. These steps are described in more detail below.

Extract, transform and load (ETL): The role of the ETL process is to extract data from the various services that are integrated into the framework. Typically, this includes data warehouses, product catalogs, and services databases. In addition, the ETL phase can include text analysis to extract representative keywords from pages browsed by the end-users, automated categorization of content, and other data integration and cleansing services. This phase is very dependant on the user requirements and the relevant products that can be used to extract data from the source systems, clean and analyze it. Conventional tools for extracting data from source systems, cleaning it and analyzing it can be used. The result of the ETL phase is a set of self-describing files containing the customer and items data, and the relationships between them.

Upload: The framework supports two modes for loading data: (a) incremental, in which previous data is preserved and only new data is loaded; and (b) complete, in which all the data is loaded from scratch. Data is loaded into a datastore which is a relational database.

Profiling: An analysis module analyzes the datastore and builds the profiles of customers and items.

Indexing: The indexing process indexes the customer and item profiles so they can be explored in the marketing and targeting tool.
The online recommendation service exposes a service that can be used to obtain recommendations for users, and present similar and popular products into a Web or WAP application.
The control module calls the other modules and refreshes data in the system.

The problem solved by the described method and system comes from the fact the events that connect customers and items (customer X bought item Y etc.) are much more numerous than the customer and item profiles. Thus, they are expensive to analyze.

### Relationship to Existing Solutions

As described, the described solution is based on a two phase model. In the first phase customer and item profiles are summarized by computing the related attributes. In the second phase, the customer and item profiles are loaded into a faceted search engine. The facets mechanism allows the exploration of the various segments, summing up the statistics and the computation of recommendations.

In business intelligence OLAP tools are usually used to provide this type of functionality. The advantage of this technique over OLAP is that it can be used to answer questions about similarity of items and customers based both on their characteristics (including free-text) and their consumption. This cannot be done in OLAP as the characteristics of a particular item or customer are not materialized. This capability to compute similarity allows the computation of recommendations as described.

Another advantage of the two phase model stems from the fact the events are summarized into the profiles. Thus, this can be done in an incremental way (i.e., considering only the “new” events in a given period of time). Additionally, since the analysis is done on the profiles, a faceted search engine can be used to display and explore this profile information.

The invention can take the form of an entirely hardware embodiment, or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for exploration of item consumption by customers, comprising:
profiling each customer with self attributes and related attributes in the form of consumed items;
profiling each item with self attributes, first order related attributes in the form of customers of the profiled item, and second order related attributes in the form of items consumed by the customers of the profiled item;
indexing the customer profiles and item profiles in a faceted search engine for exploration by a user;
wherein said profiling and indexing steps are implemented in either:
a) computer hardware configured to perform said profiling and indexing steps; or
b) computer software embodied in a non-transitory, tangible, computer-readable storage medium.

2. The method as claimed in claim 1, including:
searching the customer profiles and item profiles by user selection of one or more attributes of the customers and/or items.

3. The method as claimed in claim 1, including:
refining the indexed profiles to a segment of the data in the form of a compound logic condition of the attributes of the customer and/or items.

4. The method as claimed in claim 3, wherein given a segment, dynamically aggregating the attributes of customer or item instances belonging to the segment using the faceted search engine to aggregate facet counts.

5. The method as claimed in claim 4, including:
displaying a segment in the form of aggregated customer and item instances belonging to the segment including displaying statistics characterising the instances using the faceted search engine to aggregate facet counts.

6. The method as claimed in claim 1, including:
extracting data for the customer and item profiles from integrated services; and
loading the data into a data store for profiling.

7. The method as claimed in claim 6, including:
preserving previously loaded data and incrementally loading new data.

8. The method as claimed in claim 1, including:
recommending items to a user using similarity computed through the faceted search engine and presenting items to a user.

9. The method as claimed in claim 1, including:
providing a history navigation through historical transaction logs relating to the profiles.

10. The method as claimed in claim 1, wherein an item is one or more of the group of: a product, a service accessed, content accessed, advertisements displayed.

11. A computer program product for exploration of item consumption by customers, the computer program product comprising:
a computer readable medium;
computer program instructions operative to:
profile each customer with self attributes and related attributes in the form of consumed items;
profile each item with self attributes, first order related attributes in the form of customers of the profiled item, and second order related attributes in the form of items consumed by the customers of the profiled item;
index the customer profiles and item profiles in a faceted search engine for exploration by a user;
wherein said program instructions are stored on said computer readable medium.

12. A system for exploration of item consumption by customers, comprising:
a processor;
a profiling component for:
profiling each customer with self attributes and related attributes in the form of consumed items;
profiling each item with self attributes, first order related attributes in the form of customers of the profiled item, and second order related attributes in the form of items consumed by the customers of the profiled item;
a faceted search engine including an indexing component for indexing the customer profiles and item profiles in a faceted search engine for exploration by a user;
wherein any of said profiling component, faceted search engine and indexing component are implemented in either of computer hardware or computer software and embodied in a non-transitory, tangible, computer-readable storage medium.

13. The system as claimed in claim 12, including:
a user interface including a user searching component for searching the customer profiles and item profiles by user selection of one or more attributes of the customers and/or items.

14. The system as claimed in claim 12, including:
a refining component for refining the indexed profiles to a segment of the data in the form of a compound logic condition of the attributes of the customer and/or items.

15. The system as claimed in claim 14, wherein given a segment, the refining component dynamically aggregates the attributes of customer or item instances belonging to the segment using the faceted search engine to aggregate facet counts.

16. The system as claimed in claim 13, including:
a display for displaying a segment in the form of aggregated customer and item instances belonging to the segment including displaying statistics characterising the instances using the faceted search engine to aggregate facet counts.

17. The system as claimed in claim 12, including:
a data extracting component for extracting data for the customer and item profiles from integrated services; and
a loading component for loading the data into a data store for profiling.

18. The system as claimed in claim 12, including:
a recommending component for recommending items to a user using similarity computed through the faceted search engine and presenting items to a user.

19. The system as claimed in claim 12, including:
a history component providing a history navigation through historical transaction logs relating to the profiles.

20. A user interface for exploration of item consumption by customers, comprising:
a display of aggregated customer profiles and item profiles, wherein a customer profile includes self attributes and related attributes in the form of consumed items, and an item profile includes self attributes, first order related attributes in the form of customers of the profiled item, and second order related attributes in the form of items consumed by the customers of the profiled item;
a selection component for selecting one or more attributes of the customer and/or items displayed;
a refining component for displaying a segment in the form of a compound logic condition of the attributes of the customer and/or items.

21. The user interface as claimed in claim 20, wherein given a segment, dynamically aggregating the attributes of customer or item instances belonging to the segment using the faceted search engine to aggregate facet counts.

22. The user interface as claimed in claim 21, including:
the display displaying a segment in the form of aggregated customer and item instances belonging to the segment including displaying statistics characterising the instances using the faceted search engine to aggregate facet counts.
